(19) United States
(12) Patent Application Publication
(10) Pub. No.: US 2007/0016484 A1
(43) Pub. Date: Jan. 18, 2007

(54) Method for facilitating authorized online communication

(76) Inventors: Timothy M. Waters, Hiram, GA (US); Rick A. Hamilton II, Charlottesville, VA (US); William L. Moraca JR., McLean, VA (US); Gregory J. Boss, American Fork, UT (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/179,240

(22) Filed: Jul. 12, 2005

(51) Int. Cl. G06Q 30/00

(52) U.S. Cl. 705/26

(57) ABSTRACT

A method for facilitating authorized online communication includes receiving sponsor identification information. The method further includes receiving sign up information from at least a first and second user based on the sponsor identification information and receiving a sponsor authorization. Based on the sponsor authorization, communication between users is allowed. A computer usable medium including computer program code for accomplishing similar actions is also disclosed. A system including means for accomplishing similar actions is also disclosed.

### FIELD OF INVENTION

The present invention generally relates to communication between users of a system. More specifically, the invention relates to allowing authorized communications.

### BACKGROUND OF THE INVENTION

Communications over an unsecured network, such as online communications, pose hazards for the unwary. For example, a user may communicate with a person masquerading as a friend or a trusted person. Such hazards are especially acute for children, and many parents fear exposing their children to unsecured networks.

As means for communicating electronically proliferate, the ability of parents to supervise their children's communication is hampered. For example, many cellular phones include the ability to instant message. One solution is to eliminate a minor's access to electronic communication, but this solution is suboptimal, as many positive aspects are lost.

It is therefore a challenge to develop a method to facilitate authorized online communication to overcome these, and other, disadvantages.

### SUMMARY OF THE INVENTION

A first embodiment of the present invention is a method for facilitating authorized online communication that includes receiving sponsor identification information. The method further includes receiving sign up information from at least a first and second user based on the sponsor identification information and receiving a sponsor authorization. Based on the sponsor authorization, communication between users is allowed.

A second embodiment of the present invention is a computer usable medium including computer readable code for facilitating authorized online communication. The medium includes computer readable code for receiving sponsor identification information. The medium further includes computer readable code for receiving sign up information from at least a first and second user based on the sponsor identification information and computer readable code for receiving a sponsor authorization. The medium further includes computer readable code for allowing communication between the users based on the sponsor authorization.

A third embodiment of the present invention is a system for facilitating authorized online communication. The system includes means for receiving sponsor identification information. The system further includes means for receiving sign up information from at least a first and second user based on the sponsor identification information and means for receiving a sponsor authorization. The system further includes means for allowing communication between the users based on the sponsor authorization.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates one embodiment of a method to facilitate authorized online communication in accordance with one aspect of the invention;

FIG. 2 illustrates another embodiment of a method to facilitate authorized online communication in accordance with one aspect of the invention;

FIG. 3 illustrates another embodiment of a method to facilitate authorized online communication in accordance with one aspect of the invention;

FIG. 4 illustrates another embodiment of a method to facilitate authorized online communication in accordance with one aspect of the invention;

FIG. 5 illustrates another embodiment of a method to facilitate authorized online communication in accordance with one aspect of the invention;

FIG. 6 illustrates another embodiment of a method to facilitate authorized online communication in accordance with one aspect of the invention;

FIG. 7 illustrates another embodiment of a method to facilitate authorized online communication in accordance with one aspect of the invention;

FIG. 8 graphically illustrates nesting of communication communities, in accordance with one aspect of the invention;

FIG. 9 illustrates one embodiment of a method for creating a communication community in accordance with one aspect of the invention; and

FIG. 10 illustrates one embodiment of a method for managing users of a communication community in accordance with another aspect of the invention.

### DETAILED DESCRIPTION OF THE PRESENT INVENTION

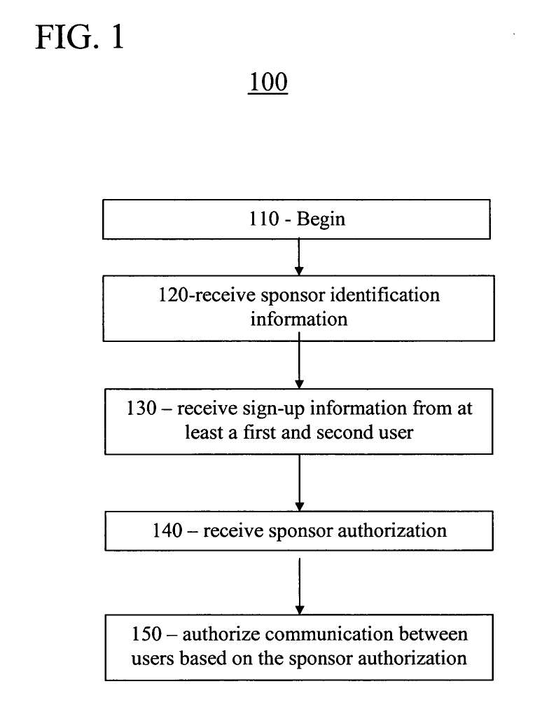

FIG. 1 illustrates one embodiment of a method 100 to facilitate authorized online communication in accordance with one aspect of the invention. Method 100 begins at step 10. Any of the inventive methods disclosed herein may be performed in any order, and the order in which the method steps are described does not limit the order in which the steps can be performed.

Method 100 continues at step 120 by receiving a sponsor identification information. In one embodiment, the sponsor identification information is received at a server, operated and provided by a service provider, connected to the Internet. In another embodiment, a peer-to-peer network receives the sponsor identification information. The sponsor identification information, in one embodiment, is then published. The publication of the sponsor identification information may be a general publication, available to any person who has access to the sponsor identification information. Alternatively, the publication of the sponsor information may be targeted to at least one individual, as described in more detail with reference to method 700 below.

In one embodiment, sponsor identification information includes personally verifiable information. Personally verifiable information is defined as any data identifying an online persona as a human being. For example, personally verifiable information may include a persons name, a persons name as reflected on a government-issued identification, a phone number (such as a home, work, or cell phone), a street address, an email address, an instant messaging identifier, an organizational identifier (such as an employer or organization), an organizational role (such as CEO, scoutmaster, teacher, etc.), and an organizational location. Other data indicative of an individual's identification can be used in addition or in place of these data. Table 1 indicates one example of sponsor identification information. In one embodiment, certain sponsor identification information is required, such as a phone number, while in other embodiments; no particular sponsor identification information is required. Any information provided by the sponsor will be publicly available, and may be perused by any person browsing a directory in one embodiment. In other embodiments, the information provided by a sponsor will only be viewable by a person investigating membership in the community, or by members of the community.

TABLE 1
Example of sponsor identification information

| | |
|---|---|
| Community Name | Community A |
| UNID: | 1029384756 |
| Sponsor Name | John Smith |
| Sponsor Address | 123 Hinckley Rd, NoTown, |
| | XX 00000 |
| Sponsor Phone | 555-1212 |
| Sponsor IM | scouts102@yahoo.com |
| Organization | Scouts |
| Sponsor's Role | Scoutmaster |
| Sponsor's Reputation | 88% |
| Intended Use | members of Scout Group |
| | 102 |
| Target Audience | Other Scouts |

As used herein, the term “sponsor” means any individual or person who provides verifiable information and will maintain control and/or responsibility, either legally, effectively, or ethically, for the membership of at least one community of users. A sponsor can be any person that desires to register a community of users and become responsible for the users in that community. For example, a sponsor is a scoutmaster. In another example, a sponsor is a teacher. In another example, a sponsor is a supervisor.

Method 100 receives sign-up information from at least a first and second user at step 130. Sign-up information is any information indicative of a desire to communicate with other users under the sponsorship of the sponsor identified with the sponsor identification information. The sign-up information is received at the same location as the sponsor identification information in one embodiment. In other embodiments, the sign-up information is received at a location in communication with the recipient of the sponsor identification information. Sign-up information is associated with the sponsor, in one embodiment. The sign-up information is stored in a database or other means to associate and track information.

Sign-up information includes information sufficient to identify a contact address for at least one user. For example, the sign-up information includes an instant messaging screen name, in one embodiment. In other embodiments, the sign-up information includes the user's name, and may include any other information deemed desirable. In one embodiment, the sponsor delineates the information to be included in a sign-up from a user. In one embodiment, receiving sign-up information includes authenticating the user, such as with a password, community name, or other similar information.

Sponsor authorization is received at step 140. The sponsor authorization is received at the same location as the sponsor identification information in one embodiment. In other embodiments, the sponsor authorization is received at a location in communication with the recipient of the sponsor identification information. Sponsor authorization is associated with at least one user sign-up information, in one embodiment. The sponsor authorization is stored in a database or other such means to associate and track information. In one embodiment, sponsor authorization to become part of the community is granted only upon approving a sign-up information. In another embodiment, sponsor authorization is a default option resulting in automatic authorization to become part of the community upon receiving sign-up information.

In one embodiment, membership in a communication community, such as upon authorization by the sponsor, involves granular access control such that unique communities can be created and nested within each other. For example, a parent can create a “family” community with members consisting of the parents family, as well as a “scouting” community with members consisting of scouts within the parent's scouting den. A scouting area leader can create an area scouting community, with each den in a geographical area nested within the area scouting community.

In response to received sponsor authorization, communication between at least a first and second user is authorized at step 150. For example, upon sponsor authorization the first and second users are authorized to send electronic communications between each other. The electronic communications may be email, instant messaging, text messages, SMS protocol messages, or the like.

In one embodiment, authorized communications are routed through a central server, or a peer-to-peer network, and marked as an authorized communication. In another embodiment, authorized communications are encrypted using any known encryption method, such that encryption and decryption are executed automatically upon sending and receipt, respectively, of an authorized message. In another embodiment, a certification is applied to authorized communications.

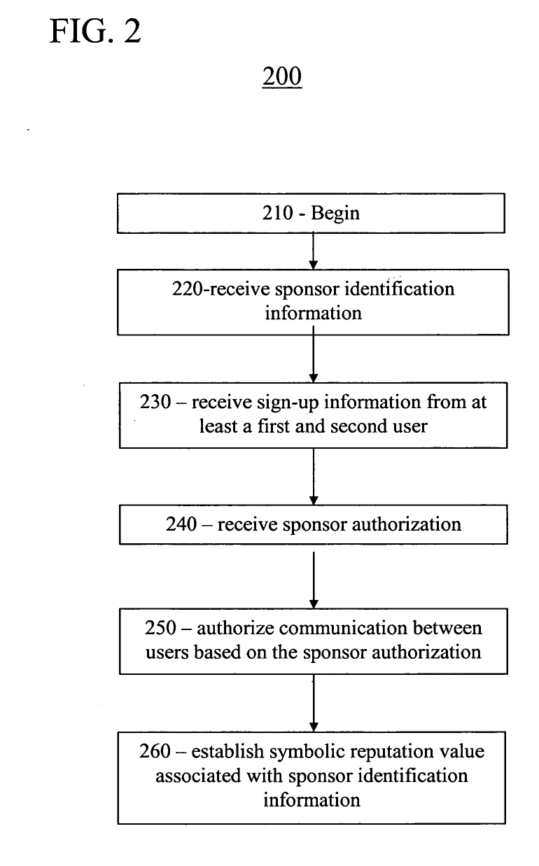

FIG. 2 illustrates another embodiment of a method 200 to facilitate authorized online communication in accordance with one aspect of the invention. Method 200 begins at step 210. Method 200 continues by receiving sponsor identification at step 220. In one embodiment, step 220 is implemented as in step 120. Method 200 then receives sign-up information from at least a first and a second user at step 230. In one embodiment, step 230 is implemented as in step 130. Sponsor authorization is received at step 240. In one embodiment, step 240 is implemented as in step 140. Communication is authorized between the first and second user at step 250. In one embodiment, step 250 is implemented as step 150.

A symbolic reputation value is established and associated with the sponsor identification information at step 260. A symbolic reputation value is denoted by an objective symbol published alongside the sponsor identification information representative of the public's perception of a sponsor's reputation. In one embodiment, each member of the public is able to increase or decrease the symbolic reputation value of the sponsor.

In one embodiment, the objective symbol is a number, such as a number from 1 to 10. In another embodiment, the objective symbol is an icon, such as a shape or number of shapes. For example, one objective symbol may be a five star rating, and each sponsor receives a symbolic reputation value of between 1 and 5 stars. In yet another embodiment, the objective symbol is a color. For example, a red color may indicate a sponsor with relatively low symbolic reputation value, while a green color may indicate a sponsor with relatively high symbolic reputation value. In another embodiment, further information, such as a comment or a reply to a comment, is included, either directly or via a link, with the published symbolic reputation value. In one embodiment, the source of a reputation rating is anonymous, while in another embodiment, the source of a rating is not anonymous. In one embodiment, a sponsor has a default symbolic reputation value of neutral. In one embodiment, a neutral symbolic reputation value is 50%. In another embodiment, a neutral symbolic reputation value is 100%. In yet another embodiment, a neutral symbolic reputation value is 2 stars.

In another embodiment, a symbolic reputation value of a first person making a rating for a second person affects the weight of the first person vote. For example, if a person with a symbolic reputation value of, say, 80% issues a symbolic reputation rating of a sponsor, such a rating would be weighted higher than a person with a symbolic reputation value of 10% and lower than a person with a symbolic reputation value of 95%.

Any modifier system can be used in accordance with the invention.

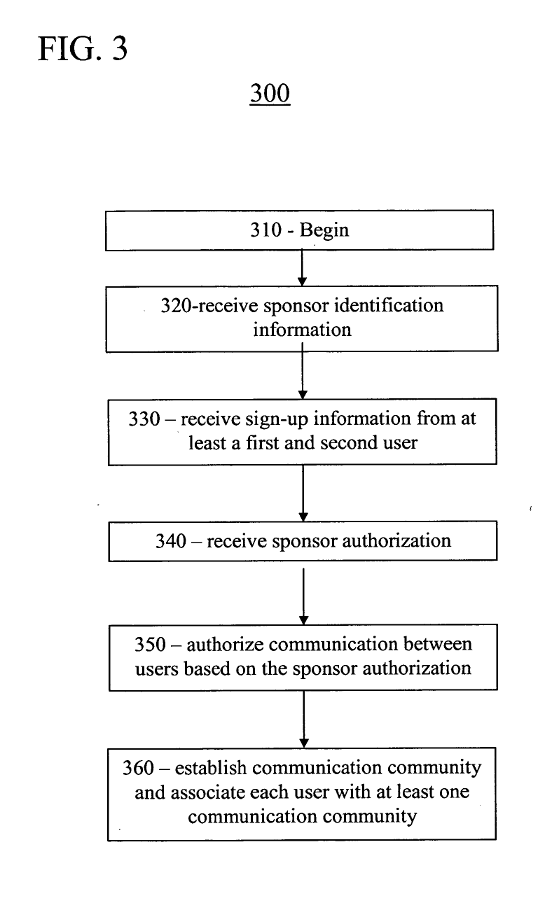

FIG. 3 illustrates another embodiment of a method 300 to facilitate authorized online communication in accordance with one aspect of the invention. Method 300 begins at step 310. Method 300 continues by receiving sponsor identification at step 320. In one embodiment, step 320 is implemented as in step 120. Method 300 then receives sign-up information from at least a first and a second user at step 330. In one embodiment, step 330 is implemented as in step 130. Sponsor authorization is received at step 340. In one embodiment, step 340 is implemented as in step 140. Communication is authorized between the first and second user at step 350. In one embodiment, step 350 is implemented as step 150.

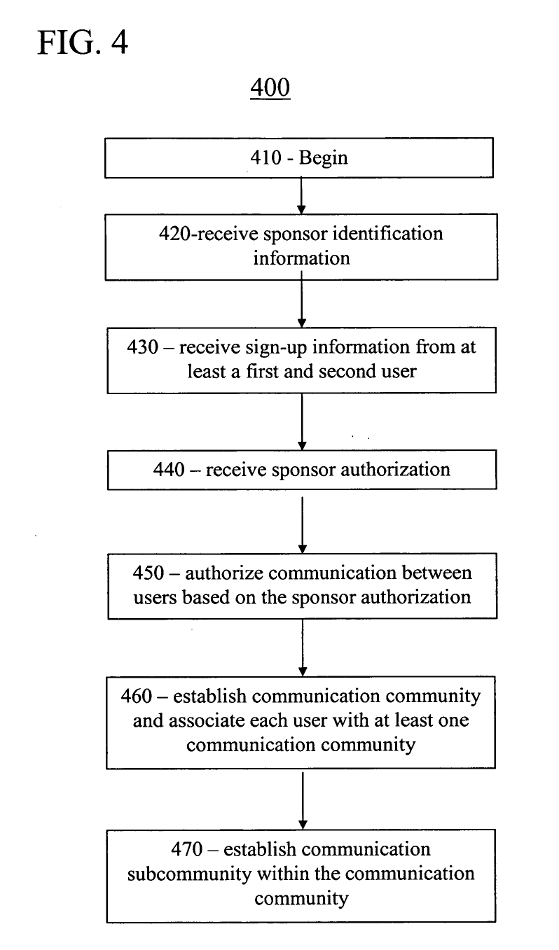

At least one communication community is established at step 360. Additionally, each user (i.e., first and second users) is associated with at least one communication community at step 360. Each user may be associated with multiple communication communities. Additionally, each communication community may have multiple users associated with the communication community. As discussed in greater detail below, with reference to FIG. 4, each communication community can include at least one communication subcommunity.

Associations between a user and a communication community are maintained using an appropriate data storage method, such as a central server, or a peer-to-peer network. Associations can be either permanent or temporary. Further, associations can be revocable. In one embodiment, the sponsor can revoke the association. In another embodiment, the user can revoke the association. In yet another embodiment, either the sponsor or the user can revoke the association. In one embodiment, a notification is sent between the user and the sponsor in response to a revocation of the association, and in another embodiment, the notification includes at least one reason for the revocation.

FIG. 4 illustrates another embodiment of a method 400 to facilitate authorized online communication in accordance with one aspect of the invention. Method 400 begins at step 410.

Method 400 continues by receiving sponsor identification at step 420. In one embodiment, step 420 is implemented as in step 120. Method 400 then receives sign-up information from at least a first and a second user at step 430. In one embodiment, step 430 is implemented as in step 130. Sponsor authorization is received at step 440. In one embodiment, step 440 is implemented as in step 140. Communication is authorized between the first and second user at step 450. In one embodiment, step 450 is implemented as step 150. At least one communication community is established, and at least one user is associated with at least one communication community at step 460. In one embodiment, step 460 is implemented as in step 360.

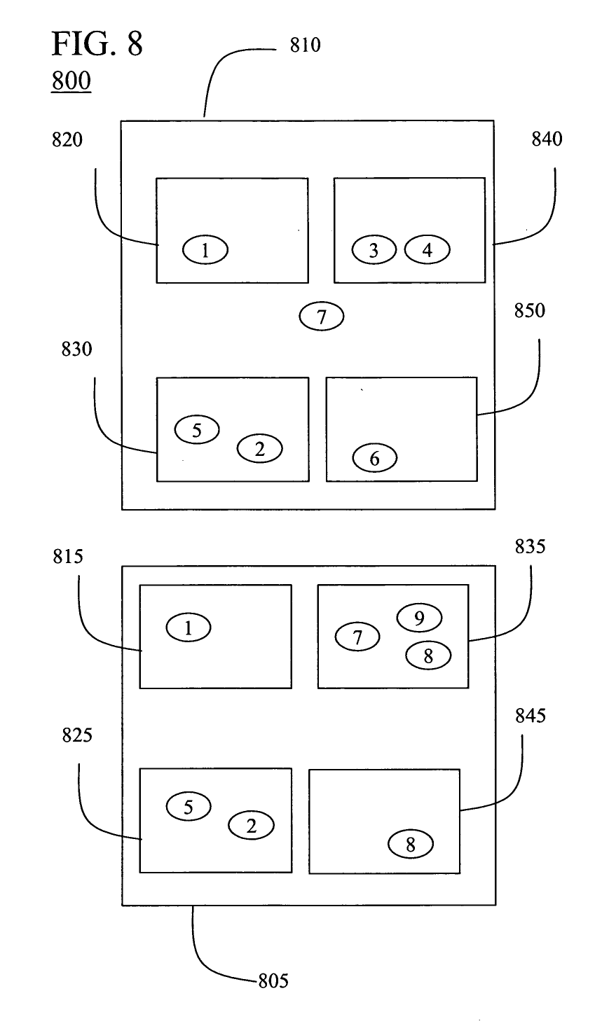

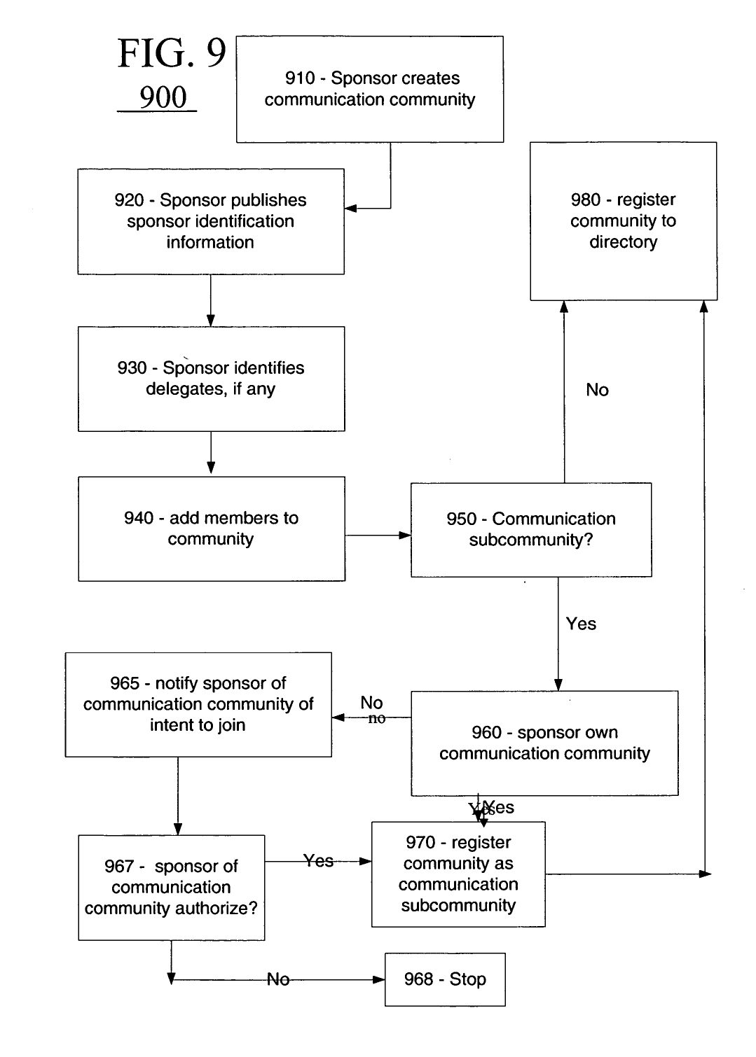

At least one communication subcommunity is established within the communication community at step 470. The communication subcommunity can be formed before, after, or concurrently with, the communication community. A communication subcommunity is any communication community with fewer, or the same number of, members than the communication community, such that each member of a communication subcommunity is a member of the communication community, but each member of the communication community is not necessarily a member of the communication subcommunity. In another embodiment, a communication subcommunity is nested within at least one other communication community. Methods for establishing a communication community and communication subcommunity are described further with reference to FIGS. 8 and 9.

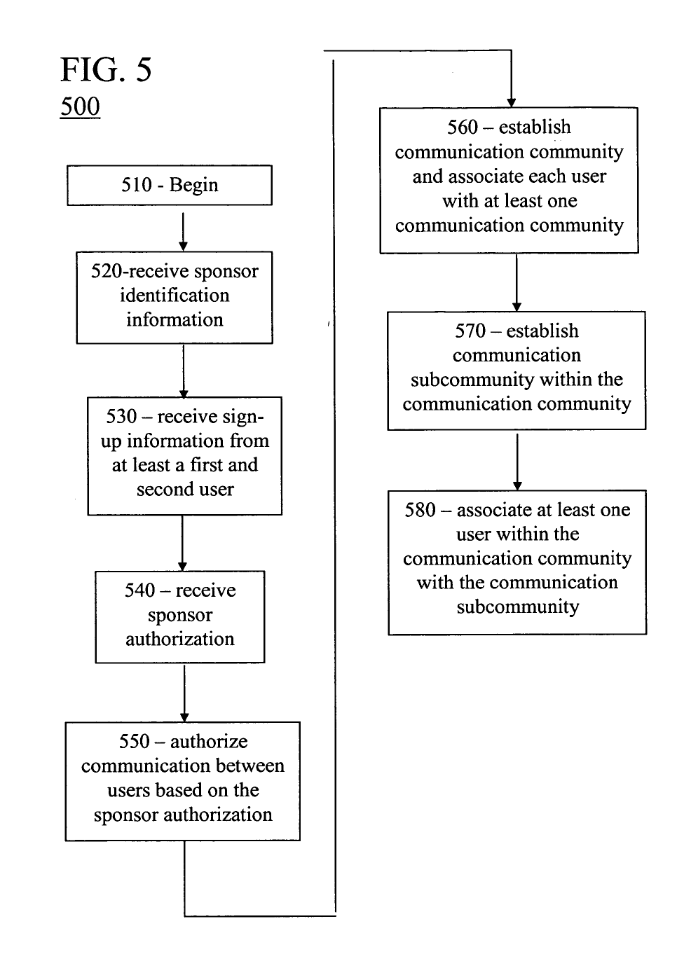

FIG. 5 illustrates another embodiment of a method 500 to facilitate authorized online communication in accordance with one aspect of the invention. Method 500 begins at step 510.

Method 500 continues by receiving sponsor identification at step 520. In one embodiment, step 520 is implemented as in step 120. Method 500 then receives sign-up information from at least a first and a second user at step 530. In one embodiment, step 530 is implemented as in step 130. Sponsor authorization is received at step 540. In one embodiment, step 540 is implemented as in step 140. Communication is authorized between the first and second user at step 550. In one embodiment, step 550 is implemented as step 150. At least one communication community is established, and at least one user is associated with at least one communication community at step 560. In one embodiment, step 560 is implemented as in step 360. A communication subcommunity is established at step 570. In one embodiment, step 570 is implemented as in step 470.

At least one user within the communication community is associated with at least one communication subcommunity in step 580. Each user may be associated with one or more communication subcommunities.

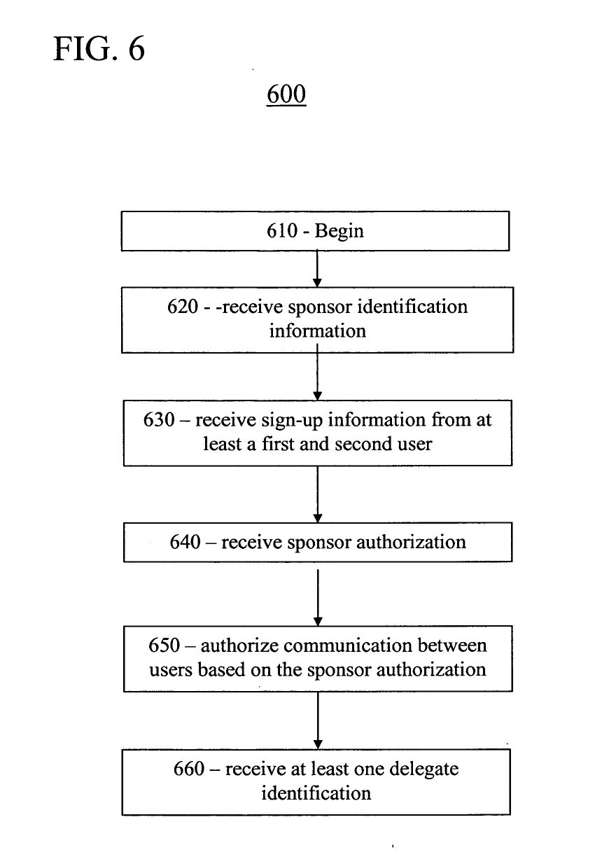

FIG. 6 illustrates another embodiment of a method 600 to facilitate authorized online communication in accordance with one aspect of the invention. Method 600 begins at step 610.

Method 600 continues by receiving sponsor identification at step 620. In one embodiment, step 620 is implemented as in step 120. Method 600 then receives sign-up information from at least a first and a second user at step 630. In one embodiment, step 630 is implemented as in step 130. Sponsor authorization is received at step 640. In one embodiment, step 640 is implemented as in step 140. Communication is authorized between the first and second user at step 650. In one embodiment, step 650 is implemented as step 150.

At least one delegate identification is received at step 660. A delegate identification indicates that the sponsor has assigned at least some duties of being a sponsor to a delegate. A delegate can be another person and the sponsor assumes responsibility for the actions of the delegate. For example, the delegate may become responsible for maintenance of a user list. In another example, the delegate may become responsible for approving sign-up information to enable a potential user to become associated with at least one communication community and become an actual user. In one embodiment, the delegate has access to an access control list. Access to an access control list can include the ability to read/write/modify the access control list, or a subset of these abilities. In one embodiment, a delegate is not visible to a user, such that the user acts solely in reliance on the sponsor identification information.

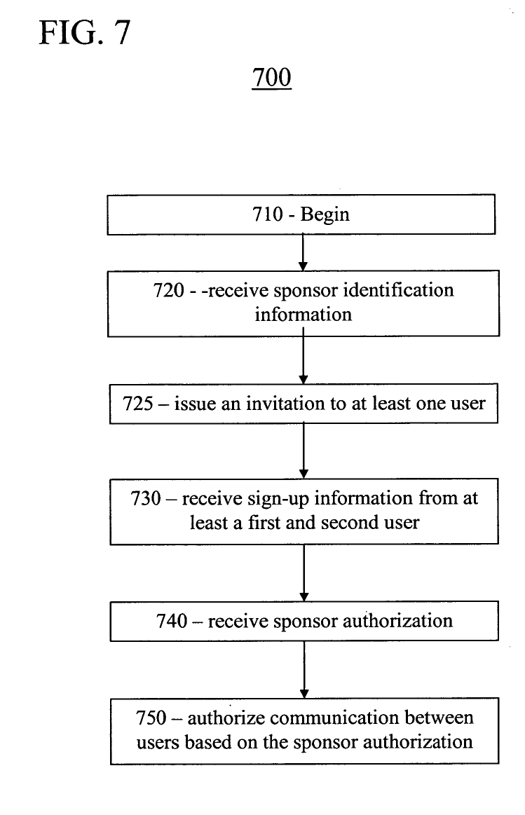

FIG. 7 illustrates another embodiment of a method 700 to facilitate authorized online communication in accordance with one aspect of the invention. Method 700 begins at step 710.

Method 700 continues by receiving sponsor identification at step 720. In one embodiment, step 720 is implemented as in step 120.

At least one invitation is issued to at least one user in response to receiving the sponsor identification information at step 725. An invitation can be any communication, electronic or otherwise, directed to a person and providing sufficient information to enable the recipient to engage in authorized communication between users based on the sponsor identification information. In one embodiment, the invitation can include an invitation to join a communication community. In another embodiment, the invitation can include an invitation to join a communication subcommunity. In one embodiment, the invitation is publicly accessible, while in other embodiments, authentication information such as a password or communication community identifier is required. In another embodiment, the invitation includes information sufficient to request that a recipient submit sign-up information and includes sufficient information as to enable a recipient to submit the sign-up information, such as an address.

Method 700 then receives sign-up information from at least a first and a second user at step 730. In one embodiment, step 730 is implemented as in step 130. Sponsor authorization is received at step 740. In one embodiment, step 740 is implemented as in step 140. Communication is authorized between the first and second user at step 750. In one embodiment, step 750 is implemented as step 150.

FIG. 8 graphically depicts the relationship between users, communication communities and communication subcommunities, in accordance with one aspect of the invention, at 800. Relationship 800 shows first communication community 810 and second communication community 805. First communication community 810 includes first communication subcommunity 820, second communication subcommunity 830, third communication subcommunity 840, and fourth communication subcommunity 850. Second communication community 805 includes fifth communication subcommunity 815, sixth communication subcommunity 825, seventh communication subcommunity 835, and eighth communication subcommunity 845. Any number of communication communities and communication subcommunities are anticipated by this disclosure.

First communication subcommunity 820 includes user “1” while second communication subcommunity 830 includes users “2” and “5”. Third communication subcommunity 840 includes users “3” and “4”, while fourth communication subcommunity 850 includes user “6.”

Fifth communication subcommunity 815 also includes user “1” while sixth communication subcommunity 825 also includes users “2” and “5”. Seventh communication subcommunity 835 includes users “7” and “9”, while eighth communication subcommunity 845 includes user “8.”

Thus, user “1” is included in both communication subcommunity 820 and communication community 810. Additionally, user “1” is further included in communication subcommunity 815 and communication community 805. Conversely, user “6” is only associated with communication subcommunity 850 and communication community 810. User “7” is included in communication community 810 and communication subcommunity 835 and communication community 805, but not any communication subcommunity associated with communication community 810.

Likewise, user “8” is associated with two communication subcommunities (835, 845) within communication community 805.

As can be seen from FIG. 8, a user may be associated with more than one communication subcommunity or communication community.

FIG. 9 illustrates one embodiment of a method 900 for registering a communication community in accordance with one aspect of the invention. Method 900 begins at step 910 wherein a sponsor creates a communication community. The sponsor publishes the sponsor identification information at step 920. In the event that the sponsor wishes to delegate authority for the maintenance of the communication community, the delegate information is provided at step 930. Delegate information may be provided at any time after creation of the communication community and prior to termination of the communication community.

Members are added to the community by the sponsor or the sponsor's delegate at step 940. A member is any person, such as the first and second user described above, who will use the communication community to exchange authorized communications. After at least one member is added to the community, method 900 determines whether the communication community created during step 910 (termed a ‘step 910 communication community’) is a communication subcommunity.

In the event that the step 910 communication community is not a communication subcommunity, method 900 proceeds to register the communication community to at least one directory at step 980. The directory may be a publicly accessible directory, listing at least one communication community available to the public. The directory may be a private directory, listing at least one communication community accessible only to certain persons, such as persons who know a password.

In the event that the step 910 communication community is a communication subcommunity, method 900 determines, at step 960, whether the sponsor of the step 910 communication community is the same as the sponsor of the communication community that will surround the step 910 communication community. In the event that the sponsor is the same, method 900 registers the step 910 communication community as a communication subcommunity at step 970 and proceeds to register the step 910 communication community with at least one directory at step 980.

In the event that the sponsor of the step 910 communication community is not the same as the putative parent communication community, method 900 notifies the sponsor of the putative parent communication community at step 965, and determines if that sponsor authorizes the step 910 communication community to become a communication subcommunity of the parent communication community at step 967.

In the event that the sponsor of the putative parent communication community does not authorize the step 910 communication community to become a communication subcommunity, method 900 proceeds to stop at step 968.

To the contrary, in the event that the sponsor of the putative parent communication community does authorize the step 910 communication community to become a communication subcommunity within the parent, then method 900 proceeds to step 970 to register the step 910 communication community as a communication subcommunity prior to proceeding to step 980 and registering the step communication community with a directory as previously disclosed.

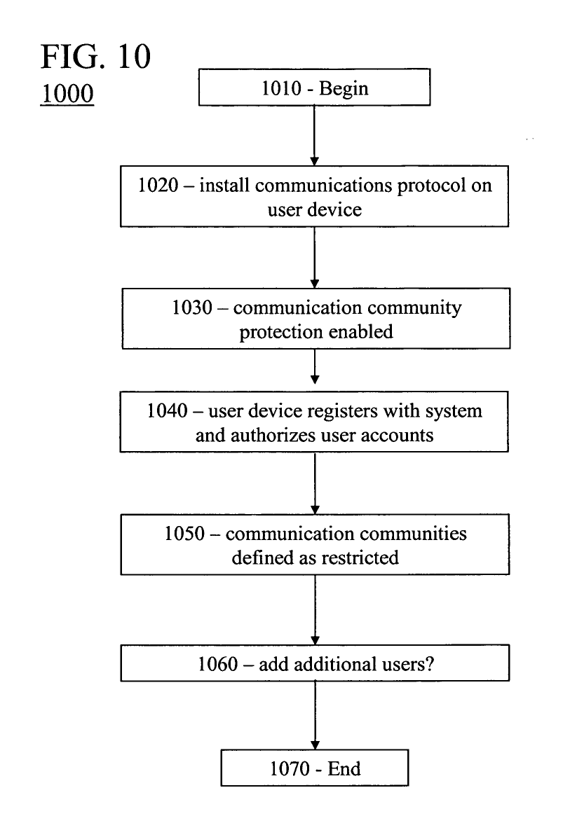

FIG. 10 illustrates one embodiment of a method 1000 to manage a user of a communication community in accordance with one aspect of the invention. Method 1000 begins at step 1010, and continues at step 1020 with the installation of a communications protocol on a user device.

In one embodiment, the communications protocol is an instant messaging protocol. In another embodiment, the communications protocol is an email client. In yet another embodiment, the communications protocol is a SMS or text message protocol. A user device can be a home computer, laptop computer, phone, or other electronic device configured to send and receive transmissions via a wire or wireless with at least one other electronic device.

Communication community protection is enabled at step 1030. Communication community protection is enabled by an administrator or other privileged user such as a parent, and prevents use of the device to communicate with users who are not members of a communication community. In one embodiment, communication community protection is a default setting, while in other embodiments, communication community protection is enabled using a menu, such as a GUI menu.

The user device registers with the system, and authorizes user accounts at step 1040. The system is defined as any communications network configured to provide the functions of communication community protection as disclosed herein. Authorizing user accounts includes, for example, subscribing to at least one communication community or communication subcommunity, or by providing sign-up information, as disclosed above.

At least one communication community is defined as restricted at step 1050. In one embodiment, defining a communication community as restricted is implemented as method 900. In another embodiment, defining a communication community as restricted comprises defining at least one set of conditions precedent to authorizing a user to communicate with at least one other user using the communication community, and wherein the authorization is responsive to publishing at least one sponsor identification information. Conditions precedent to authorizing can include any appropriate conditions, such as payment of a fee, joining another group, an agreement to participate in certain activities, recruiting new members, or the like.

Additional users are added, if appropriate, at step 1060, and method 1000 ends at step 1070.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

1. A method for facilitating authorized online communication, the method comprising:
receiving sponsor identification information;
receiving sign up information from at least a first user and a second user in response to the sponsor identification information;
receiving a sponsor authorization; and
allowing communication between the users based on the sponsor authorization.

2. The method of claim 1 wherein the communication is an instant messaging communication transmitted over a network.

3. The method of claim 1 wherein the sponsor identification information includes personally verifiable information.

4. The method of claim 1 further comprising establishing a symbolic reputation value associated with the sponsor identification information.

5. The method of claim 1 further comprising:
establishing at least one communication community based on the sponsor identification information; and
associating each user with at least one communication community.

6. The method of claim 5 further comprising:
establishing at least one communication subcommunity within the established communication community.

7. The method of claim 6 further comprising:
associating at least one user associated with the communication community with the communication subcommunity.

8. The method of claim 1 further comprising:
receiving at least one delegate identification information in response to receiving the sponsor identification information.

9. The method of claim 1 further comprising:
issuing an invitation to at least one user in response to receiving the sponsor identification information.

10. A computer usable medium including computer readable code for facilitating authorized online communication, the medium comprising:
computer readable code for receiving sponsor identification information;
computer readable code for receiving sign up information from at least a first and second user based on the sponsor identification information;
computer readable code for receiving a sponsor authorization; and
computer readable code for allowing communication between the users based on the sponsor authorization.

11. The medium of claim 10 wherein the communication is an instant messaging communication transmitted over a network.

12. The medium of claim 10 wherein the sponsor identification information includes personally verifiable information.

13. The medium of claim 10 further comprising computer readable code for establishing a symbolic reputation value associated with the sponsor identification information.

14. The medium of claim 10 further comprising:
computer readable code for establishing at least one communication community based on the sponsor identification information; and
computer readable code for associating each user with at least one communication community.

15. The medium of claim 14 further comprising:
computer readable code for establishing at least one communication subcommunity within the established communication community.

16. The medium of claim 15 wherein users associated with the communication community become associated with the communication subcommunity.

17. The medium of claim 10 further comprising:
computer readable code for receiving at least one delegate identification information in response to receiving the sponsor identification information.

18. The medium of claim 10 further comprising:
computer readable code for issuing an invitation to at least one user in response to receiving the sponsor identification information.

19. A system for facilitating authorized online communication, the system comprising:
means for receiving sponsor identification information;
means for receiving sign up information from at least a first and second user based on the sponsor identification information;
means for receiving a sponsor authorization; and
means for allowing communication between the users based on the sponsor authorization.
